(19) United States
(12) Patent Application Publication
(10) Pub. No.: US 2006/0170777 A1
(43) Pub. Date: Aug. 3, 2006

(54) Apparatus method and system for animating symbol transitions

(76) Inventor: Spencer Lawrence Whitham, Orem, UT (US)

Correspondence Address: SPENSER WHITHAM, 211 N 550 E, OREM, UT, 84097, US

(21) Appl. No.: 11/047,147

(22) Filed: Jan. 31, 2005

(51) Int. Cl. H04N 3/28

(52) U.S. Cl. 348/206

(57) ABSTRACT

An apparatus, method, and system for animating the transition between symbols. Symbol segments that form a symbol are transformed by way of intermediate steps to form other symbols. In one approach the symbols are transformed by rotating symbol segments to create additional symbols. In another approach the symbols are transformed by changing the pattern of illuminating elements forming the symbol segments. Not only does the invention display a set of symbols, but also creates interesting animated patterns as one symbols morphs into another symbol.

### BACKGROUND OF THE INVENTION

1. Field of the Invention

This present invention relates generally to display apparatus, methods, and systems and more particularly to apparatus, methods, and systems for animating symbol transitions.

2. Description of the Related Art

The display of symbols is widespread in our modern society. In cases where symbols change, it is desirable to employ a display that is easily changed from one symbol to another. For example, during a game the score may change multiple times, hence it is desirable that the numerals on a scoreboard changes multiple times. Computer monitors are another example wherein symbols change constantly.

Techniques have been developed to divide symbols into elements, wherein multiple symbols may be displayed by changing the characteristics of the elements. For example, a typical computer monitor may define an array of dots 12 wide and 15 high and display various alphanumeric symbols by illuminating dots within the matrix corresponding to the physical appearance of a selected symbol. Where a limited set of symbols is required, a specialized display such as a seven-segment display is often used. FIG. 1 illustrates a typical digital display 100 composed of 4 positions for numerals, each position composed of seven segments. By illuminating selected segments, the numerals 0-9, and the alpha characters A, B, C, D, E, and F may be displayed.

Typical symbol displays proceed directly from one symbol to a subsequent symbol. The lack of a transition between symbols creates a sterile, uninteresting display, particularly where a predictable sequence of symbols are involved such as a clock display.

What is needed is a method, apparatus, and system that displays symbols and also animates the transitions between symbols. Ideally, such a method, apparatus, and system would provide a decorative and interesting appearance as symbols are displayed.

### SUMMARY OF THE INVENTION

The present invention animates transitions from one symbol to another symbol while maintaining the identity of the visual segments that constitute the symbols. Each visual segment may be a display segment or a set of elements that form a visual segment. In some embodiments such as mechanical embodiments, one segment may cover another segment or move behind a segment to give the impression of two segments merging into a single segment. Segments may also move behind a frame or some other hiding member to give the impression of disappearing. Conversely, a hidden segment may rotate or move to a visible position to give the impression of re-appearing.

In certain embodiments such as electronic embodiments, segments may ‘worm’ or ‘snake’ from one position to another position. Segments may also merge with or split from another segment. Segments may also stretch or shrink in conjunction with an animated transition from one symbol to another symbol. Segments may be displayed as a contiguous region of pixels or display elements such as LED's or lights.

In one aspect of the present invention, an apparatus for displaying and animating symbols, includes a set of display elements that display a current symbol selected from a set of displayable symbols and an animator that moves one or more selected visual segments from a first position corresponding to the current symbol to a second position corresponding to a subsequent symbol via one or more intermediate positions. In addition to moving the selected segment, the animator may also morph the selected visual segments to create a variety of transition effects.

The visual segments from which the displayed symbols are formed may be dials, wands, projected beams, or contiguous regions of activated elements such as pixels, lights, sub-segments, or the like. In one embodiment, visual segments are mechanical wands that rotate about various segment junctions. In another embodiment, a visual segment is a contiguous region of activated elements that may move or morph as display elements adjacent to the region are activated and display elements at the edge of the contiguous region are deactivated.

In certain embodiments, the intermediate positions associated with a moving visual segment correspond to multiple fixed display segments that are sequentially activated for finite durations in order to transition the display symbol from the current symbol to the subsequent symbol. In one embodiment, the displayable symbols include the numerals 0-9 and the letters A-F.

In another aspect of the present invention, a system for displaying symbols includes a display comprising a set of symbol fields, each symbol field comprising a set of display elements that display a selected symbol from a set of displayable symbols and the aforementioned animator that transitions each symbol field from one displayed symbol to another. The plurality of symbol fields may display information such as time or temperature in a visually appealing manner.

The present invention increases the appeal of symbol-oriented displays. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a typical multi-segment display;

FIG. 2 is a diagram illustrating one embodiment of a segment animation apparatus of the present invention;

FIG. 3 is a diagram illustrating the reference locations used to identify a segment bar position in accordance with the present invention;

FIG. 4 is a diagram illustrating one embodiment of a method to transition from the numeral 0 to the numeral 1 of the present invention;

FIG. 5 is a diagram illustrating one embodiment of a method to transition from the numeral 1 to the numeral 2 of the present invention;

FIG. 6 is a diagram illustrating one embodiment of a method to transition from the numeral 2 to the numeral 3 of the present invention;

FIG. 7 is a diagram illustrating one embodiment of a method to transition from the numeral 3 to the numeral 4 of the present invention;

FIG. 8 is a diagram illustrating one embodiment of a method to transition from the numeral 4 to the numeral 5 of the present invention;

FIG. 9 is a diagram illustrating one embodiment of a method to transition from the numeral 5 to the numeral 6 of the present invention;

FIG. 10 is a diagram illustrating one embodiment of a method to transition from the numeral 6 to the numeral 7 of the present invention;

FIG. 11 is a diagram illustrating one embodiment of a method to transition from the numeral 7 to the numeral 8 of the present invention;

FIG. 12 is a diagram illustrating one embodiment of a method to transition from the numeral 8 to the numeral 9 of the present invention;

FIG. 13 is a diagram illustrating one embodiment of a method to transition from the numeral 9 to the numerals 1 and 0 of the present invention;

FIG. 14 is a diagram illustrating a second embodiment of a method to transition from the numeral 9 to the numerals 1 and 0 of the present invention;

FIG. 15 is a diagram illustrating one embodiment of a method to transition from the numerals 1 and 2 to the numeral 1 of the present invention;

FIG. 16 is a diagram illustrating a second embodiment of a method to transition from the numerals 1 and 2 to the numeral 1 of the present invention;

FIG. 17 is a diagram illustrating one embodiment of a method to transition from a neutral symbol to the numeral 1 of the present invention;

FIG. 18 is a diagram illustrating one embodiment of a method to transition from a neutral symbol to the numeral 2 of the present invention;

FIG. 19 is a diagram illustrating one embodiment of a method to transition from a neutral symbol to the numeral 3 of the present invention;

FIG. 20 is a diagram illustrating one embodiment of a method to transition from a neutral symbol to the numeral 4 of the present invention;

FIG. 21 is a diagram illustrating one embodiment of a method to transition from a neutral symbol to the numeral 5 of the present invention;

FIG. 22 is a diagram illustrating one embodiment of a method to transition from a neutral symbol to the numeral 6 of the present invention;

FIG. 23 is a diagram illustrating one embodiment of a method to transition from a neutral symbol to the numeral 7 of the present invention;

FIG. 24 is a diagram illustrating one embodiment of a method to transition from a neutral symbol to the numeral 8 of the present invention;

FIG. 25 is a diagram illustrating one embodiment of a method to transition from a neutral symbol to the numeral 9 of the present invention;

FIG. 26 is a diagram illustrating one embodiment of a method to transition from a neutral symbol to the numeral 0 of the present invention;

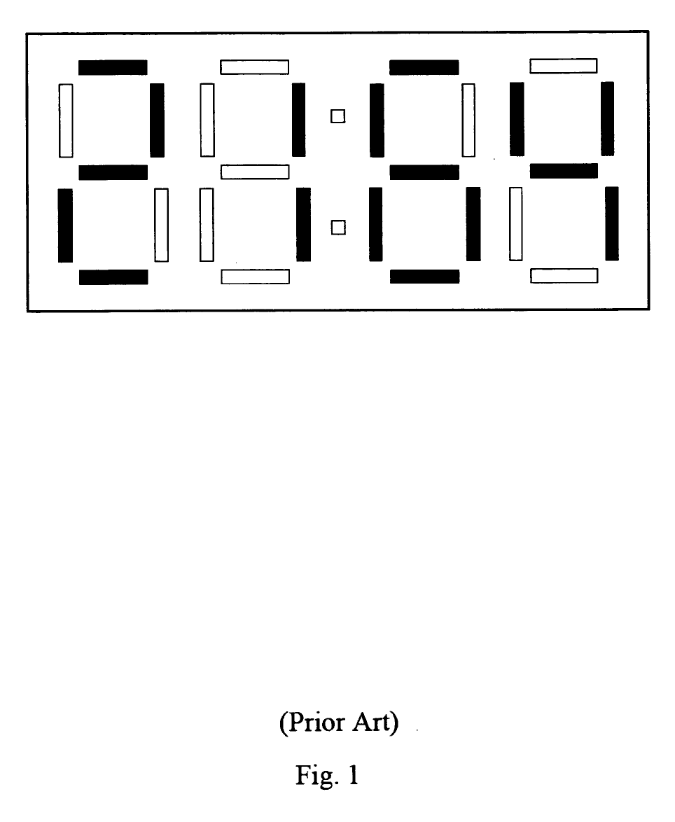

CD-ROM included provides digital examples of process in action;

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. The following description provides numerous specific details, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The present invention displays symbols using visual segments, the segments being composed of bars or multiple elements that form a bar. In some embodiments, the visual segments can pivot about various points on a symbol frame. In other embodiments, the visual segments are formed from discrete elements, each element characterized by an illuminated state and a dark state.

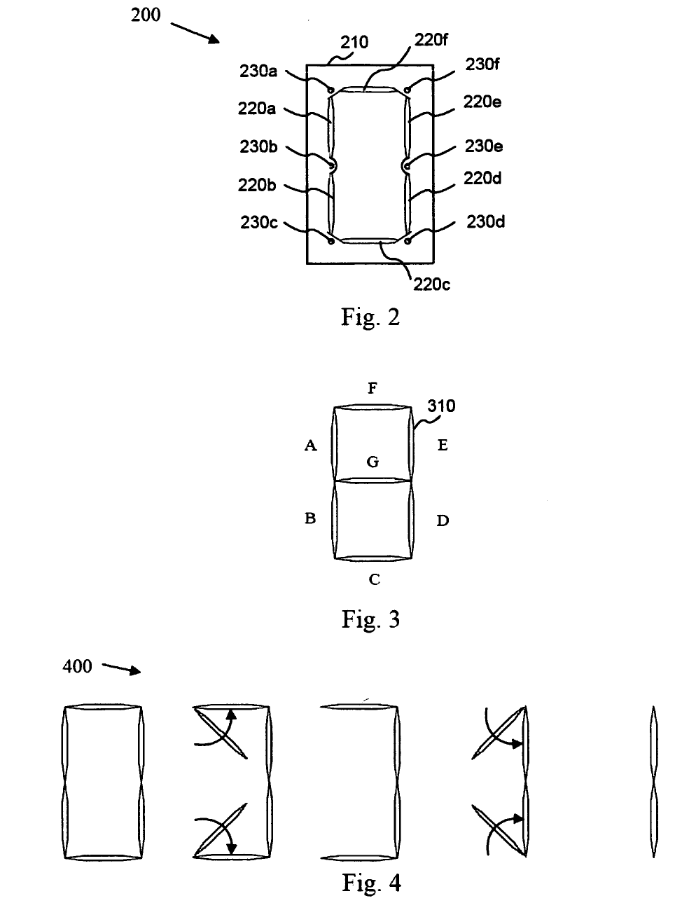

FIG. 2 depicts one embodiment of a segment animation apparatus 200 of the present invention. The segment animation apparatus 200 includes a symbol frame 210, segment bars 220a-220f, and pivots 230a-230f. The segment bars 220 attach to the symbol frame 210 by way of the corresponding pivots 230. In one embodiment, multiple segment bars 220 are attached to each pivot 230. The segment bars 220a, 220c, 220d, and 220f rotate about the pivots 230a, 230c, 230d, and 230f to traverse an arc of 90 degrees, and segment bars 220b and 220e rotate about pivots 230b, and 230e to traverse an arc of either 90 degrees or 180 degrees.

In one embodiment a segment bar 220 may rotate under the segment frame, thus becoming invisible to an observer. In another embodiment, a segment bar 220 may become visible to an observer by transitioning to an illuminated state and invisible to an observer by transitioning to a dark state.

Those experienced in the art will appreciate that the configuration of the symbol frame 210 is closely associated with the symbol set to be displayed. The depicted embodiment of the segment animation apparatus 200 is capable of displaying a symbol set that includes the numerals 0-9 and the alpha characters A, B, C, D, E, and F. Alternate symbol frames may easily be devised to allow display of a variety of other symbol sets. Those experienced in the art will also appreciate that rotating a segment bar 220 about a pivot 230 may be simulated by electronic means such as the progressive illumination of a set of segment bars 220 in partially rotated positions, or the like.

FIGS. 2 and 3 depict the reference locations used to identify a position of a visual segment 310. A segment bar 220 that is illuminated or otherwise distinguishable from the background is called a visual segment 310. Location A as shown in FIG. 3 is defined as the location between pivot 230a and pivot 230b and may be populated by visual segment 220a pointing downward from pivot 230a or by visual segment 220b pointing upward from pivot 230b. Location B is defined as the location between pivot 230b and pivot 230c and may be the populated by visual segment 220b pointing downward from pivot 230b or by visual segment 220c pointing upward from pivot 230c. Location C is defined as the location between pivot 230c and pivot 230d and may be the populated by visual segment 220c pointing rightward from pivot 230c or by visual segment 220d pointing leftward from pivot 230d.

Location D is defined as the location between pivot 230d and pivot 230e and may be the populated by visual segment 220d pointing upward from pivot 230d or by visual segment 220e pointing downward from pivot 230e. Location E is defined as the location between pivot 230e and pivot 230f and may be populated by visual segment 220e pointing upward from pivot 230e or by visual segment 220f pointing downward from pivot 230f. Location F is defined as the location between pivot 230f and pivot 230a and may be populated by visual segment 220f pointing leftward from pivot 230f or by visual segment 220a pointing rightward from pivot 230a. Location G is defined as the location between pivot 230b and pivot 230e and may be populated by visual segment 220b pointing rightward from pivot 230b or by visual segment 220e pointing leftward from pivot 230e.

FIGS. 4-16 show methods to transition from one numeral to another numeral. Each method includes at least one rotation of a visual segment 220 from one location to another location, the locations being defined in FIG. 3. A low rotation speed allows an observer to see one numeral morph into another numeral.

FIG. 4 depicts one embodiment of a method 400 to transition from the numeral 0 to the numeral 1 of the present invention. The method 400 starts with locations A, B, C, D, E, and F visible. The method 400 rotates a visual segment 220 in location A to location F and at the same time rotates a visual segment 220 in location B to location C. Subsequently, the method 400 rotates a visual segment 220 in location F to location E and at the same time rotates a visual segment 220 in location C to location D to form the numeral 1.

FIG. 5 depicts one embodiment of a method 500 to transition from the numeral 1 to the numeral 2 of the present invention. The method 500 starts with locations E and F visible forming the numeral 1. The method 500 rotates a visual segment 220 from location E to location F leaving a visual segment 220 at location E and at the same time rotates a visual segment 220 from location D to location C leaving a visual segment at location D. Then the method 500 rotates a visual segment from location C to location B leaving a visual segment 220 at location C. Subsequently, the method 500 rotates a visual segment 220 from location D to location G to form the numeral 2.

FIG. 6 depicts one embodiment of a method 600 to transition from the numeral 2 to the numeral 3 of the present invention. The method 600 starts with locations B, C, E, F, and G visible forming the numeral 2. The method 600 rotates a visual segment 220 from location B to location C. Then method 600 rotates a visual segment 220 from location C to location D leaving a visual segment 220 at location C to form the numeral 3.

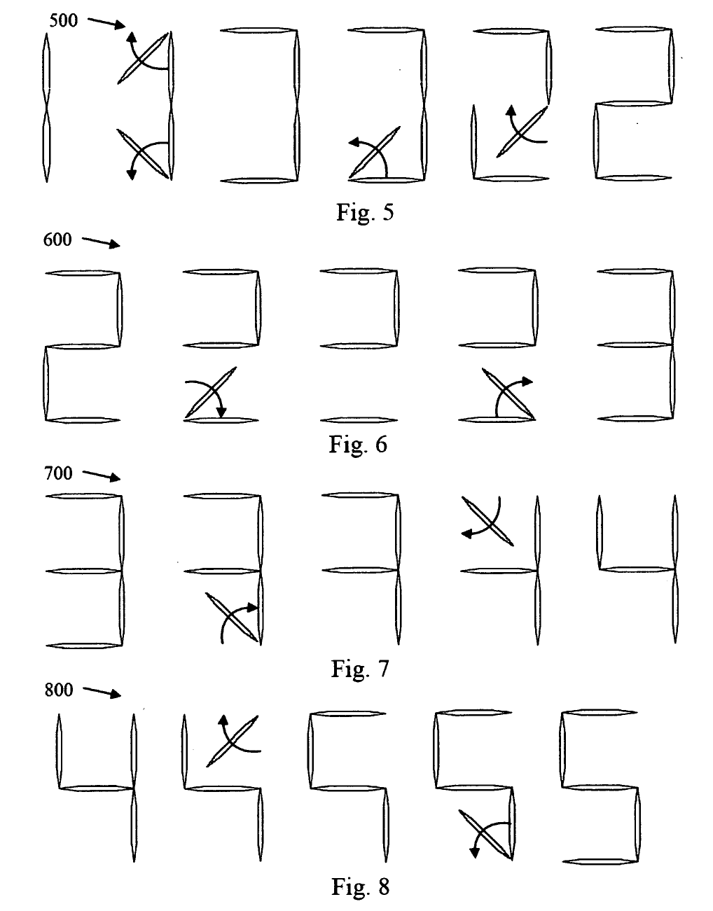

FIG. 7 depicts one embodiment of a method 700 to transition from the numeral 3 to the numeral 4 of the present invention. The method 700 starts with locations C, D, E, F, and G visible forming the numeral 3. The method 700 rotates a visual segment 220 from location C to location D, and then rotates a visual segment 220 from location F to location A to form the numeral 4.

FIG. 8 depicts one embodiment of a method 800 to transition from the numeral 4 to the numeral 5 of the present invention. The method 800 starts with locations A, D, E, and G visible forming the numeral 4. The method 800 rotates a visual segment 220 from location F to location E, then rotates a visual segment 220 from location D to location C leaving a visual segment 220 at location D to form the numeral 5.

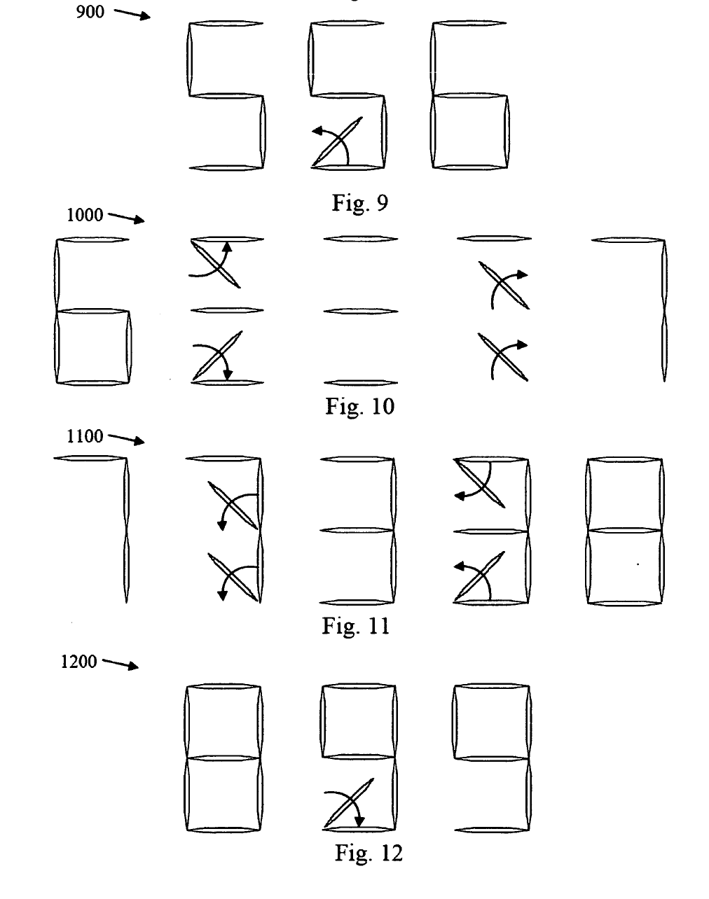

FIG. 9 depicts one embodiment of a method 900 to transition from the numeral 5 to the numeral 6 of the present invention. The method 900 starts with locations A, C, D, F, and G visible forming the numeral 5. The method 900 rotates a visual segment 220 from location C to location B leaving a visual segment 220 at location C to form the numeral 6.

FIG. 10 depicts one embodiment of a method 1000 to transition from the numeral 6 to the numeral 7 of the present invention. The method 1000 starts with locations A, B, C, D, F, and G visible forming the numeral 6. The method 1000 rotates a visual segment 220 from location A to location F and at the same time rotates a visual segment 220 from location B to location C. Then the method 1000 rotates a visual segment 220 from location C to location D and at the same time rotates a visual segment 220 from location G to location E to form the numeral 7.

FIG. 11 depicts one embodiment of a method 1100 to transition from the numeral 7 to the numeral 8 of the present invention. The method 1100 starts with locations D, E, and F visible forming the numeral 7. The method 1100 rotates a visual segment 220 from location D to location C leaving a visual segment 220 at location D and at the same time rotates a visual segment 220 from location E to location G leaving a visual segment 220 at location E. Then the method 1100 rotates a visual segment 220 from location F to location A leaving a visual segment at location F and at the same time rotates a visual segment 220 from location C to location B leaving a visual segment 220 at location C to form the numeral 8.

FIG. 12 depicts one embodiment of a method 1200 to transition from the numeral 8 to the numeral 9 of the present invention. The method 1200 starts with locations A, B, C, D, E, F, and G visible forming the numeral 8. The method 1200 rotates a visual segment 220 from location B to location C to form the numeral 9.

FIG. 13 depicts one embodiment of a method 1300 to transition from the numeral 9 to the numerals 1 and 0 of the present invention. The method 1300 starts with locations A, C, D, E, F, and G visible, forming the numeral 9. The method 1300 rotates a visual segment 220 from location G to location E. Then the method 1300 rotates a visual segment 220 from location C to location B leaving a visual segment 220 at location C. Thereafter, the method 1300 translates visual segments 220 in locations A and B to the left, leaving visual segments 220 in locations A and B to form the numerals 1 and 0.

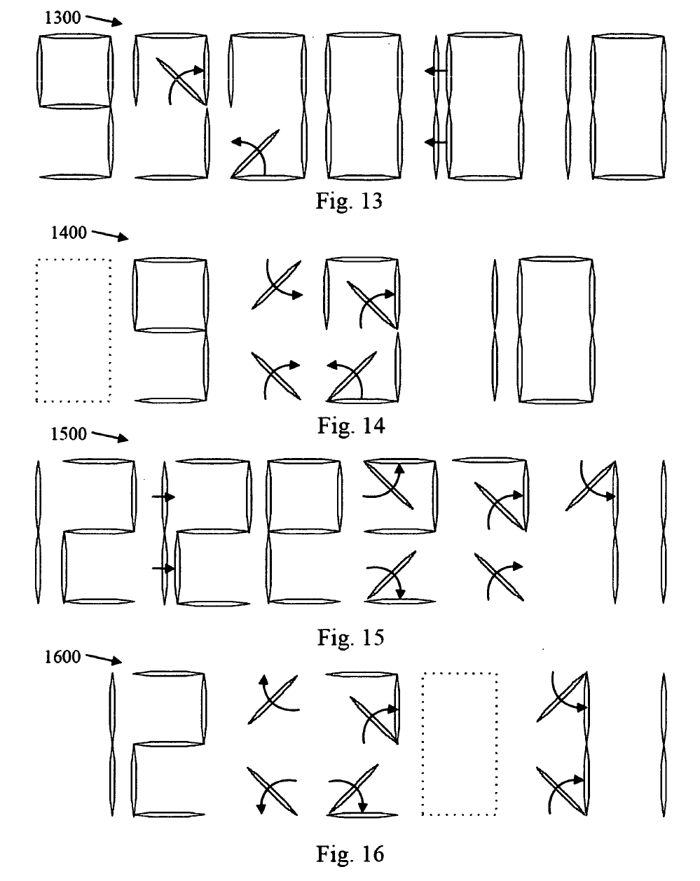

FIG. 14 depicts an embodiment of a method 1400 to transition from the numeral 9 to the numerals 1 and 0 of the present invention. The method 1400 starts with a blank segment frame 210 in a left position and locations A, C, D, E, F, and G visible forming the numeral 9 in a right position. The method 1400 rotates a visual segment 220 from location G to location E and at the same time rotates a visual segment 220 from location C to location B leaving a visual segment 220 in location C to form the numeral 0 in the right position. Simultaneously, the method 1400 rotates a visual segment 220 from behind the symbol frame 210 to location E and at the same time rotates a visual segment 220 from behind the symbol frame 210 to location D to form the numeral I in the left position. In another embodiment, the method 1400 illuminates a visual segment 220 in location F and location C and then rotates the visual segment 220 from location F to location E while rotating the visual segment 220 from location C to location D to form the numeral 1 in the left position.

FIG. 15 depicts one embodiment of a method 1500 to transition from the numerals 1 and 2 to the numeral 1 of the present invention. The method 1500 starts with left-translated locations A and B visible, and locations B, C, E, F, and G visible forming the numerals 1 and 2. The method 1500 translates the left-translated visual segments 220 in location A and location B to the right, merging the visual segments 220 into location A and location B of the symbol frame 210. Then the method 1500 rotates a visual segment 220 from location A to location F and at the same time rotates a visual segment 220 from location B to location C. Thereafter, the method 1500 rotates a visual segment 220 from location C to location D and at the same time rotates a visual segment from location G to location E. Subsequently, the method 1500 rotates a visual segment 220 from location F to location E to form the numeral 1.

FIG. 16 depicts one embodiment of a method 1600 to transition from the numerals 1 and 2 to the numeral 1 of the present invention. The method 1600 starts with locations D and E visible forming the numeral 1 in a left position and locations B, C, E, F, and G visible forming the numeral 2 in a right position. The method 1600 rotates a visual segment 220 from location G to location E and at the same time rotates a visual segment 220 from location B to location C. Simultaneously, the method 1600 rotates a visual segment 220 from location E into a position behind the symbol frame 210 and at the same time rotates a visual segment 220 from location D into a position behind the symbol frame 210 in the left position to form a vacant symbol frame 210 in the left position. Then the method 1600 rotates a visual segment 220 from location F to location E and at the same time rotates a visual segment 220 from location C to location D to form the numeral 1 in the right position. In another embodiment, the method 1600 rotates a visual segment 220 from location E into location F and at the same time rotates a visual segment 220 from location D into location C, then quenches illumination in location C and location F to form a vacant symbol frame 210 in the left position.

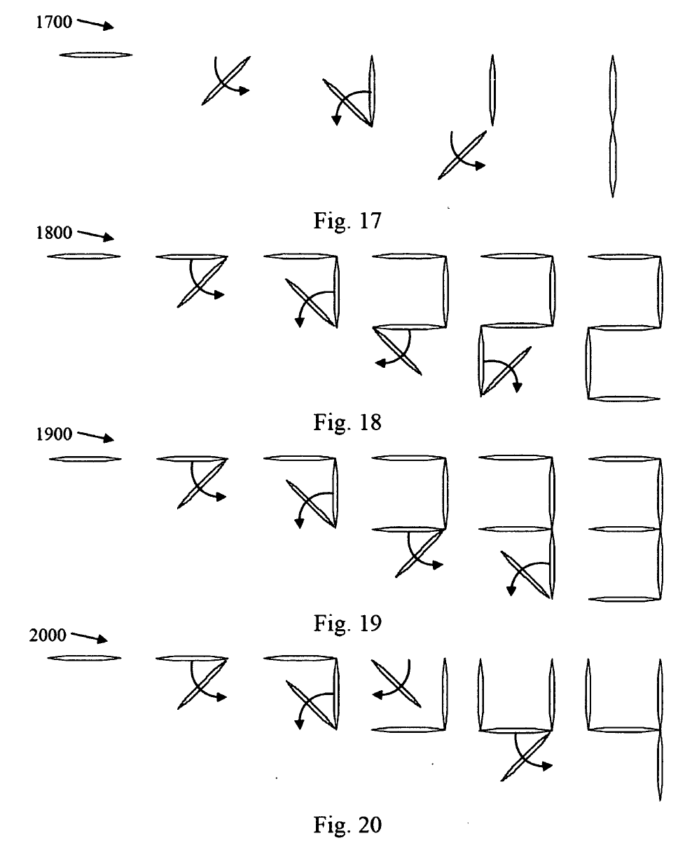

FIGS. 17-26 show methods to transition from a common neutral symbol to a numeral from 0-9. In one embodiment, a first numeral morphs into a second numeral by reversing the method steps used to display the first numeral to arrive at the common neutral symbol and then performing a method to display the second numeral. Each method includes at least one rotation of a visual segment 220 from one location to another location as defined in FIG. 3. The low rotation speed allows an observer to see one numeral morph into another numeral. Those experienced in the art will appreciate that the common neutral symbol can be arbitrarily chosen and that methods showing transitions may be easily modified to provide a variety of animation steps.

FIG. 17 depicts one embodiment of a method 1700 to transition from a neutral symbol to the numeral 1 of the present invention. The method 1700 starts with location F visible. The method 1700 rotates a visual segment 220 from location F to location E, then rotates a visual segment 220 from location E to location D, leaving a visual segment 220 in location E to form the numeral 1.

FIG. 18 depicts one embodiment of a method 1800 to transition from a neutral symbol to the numeral 2 of the present invention. The method 1800 starts with location F visible. The method 1800 rotates a visual segment 220 from location F to location E leaving a visual segment 220 in location F. Then the method 1800 rotates a visual segment 220 from location E to location G leaving a visual segment 220 in location E. Thereafter, the method 1800 rotates a visual segment 220 from location G to location B leaving a visual segment 220 in location G. Subsequently, the method 1800 rotates a visual segment 220 from location B to location C leaving a visual segment 220 in location B to form the numeral 2.

FIG. 19 depicts one embodiment of a method 1900 to transition from a neutral symbol to the numeral 3 of the present invention. The method 1900 starts with location F visible. The method 1900 rotates a visual segment 220 from location F to location E leaving a visual segment 220 in location F. Then the method 1900 rotates a visual segment 220 from location E to location G leaving a visual segment 220 in location E. Thereafter, the method 1900 rotates a visual segment 220 from location G to location D leaving a visual segment 220 in location G. Subsequently, the method 1900 rotates a visual segment 220 from location D to location C leaving a visual segment 220 in location D to form the numeral 3.

FIG. 20 depicts one embodiment of a method 2000 to transition from a neutral symbol to the numeral 4 of the present invention. The method 2000 starts with location F visible. The method 2000 rotates a visual segment 220 from location F to location E leaving a visual segment 220 in location F. Then the method 2000 rotates a visual segment 220 from location E to location G leaving a visual segment 220 in location E. Thereafter, the method 2000 rotates a visual segment 220 from location F to location A. Subsequently, the method 2000 rotates a visual segment 220 from location G to location D to form the numeral 4.

FIG. 21 depicts one embodiment of a method 2100 to transition from a neutral symbol to the numeral 5 of the present invention. The method 2100 starts with location F visible. The method 2100 rotates a visual segment 220 from location F to location A leaving a visual segment 220 in location F. Then the method 2100 rotates a visual segment 220 from location A to location G leaving a visual segment 220 in location A. Thereafter, the method 2100 rotates a visual segment 220 from location G to location D leaving a visual segment 220 in location G. Subsequently, the method 2100 rotates a visual segment 220 from location D to location C leaving a visual segment 220 in location D to form the numeral 5.

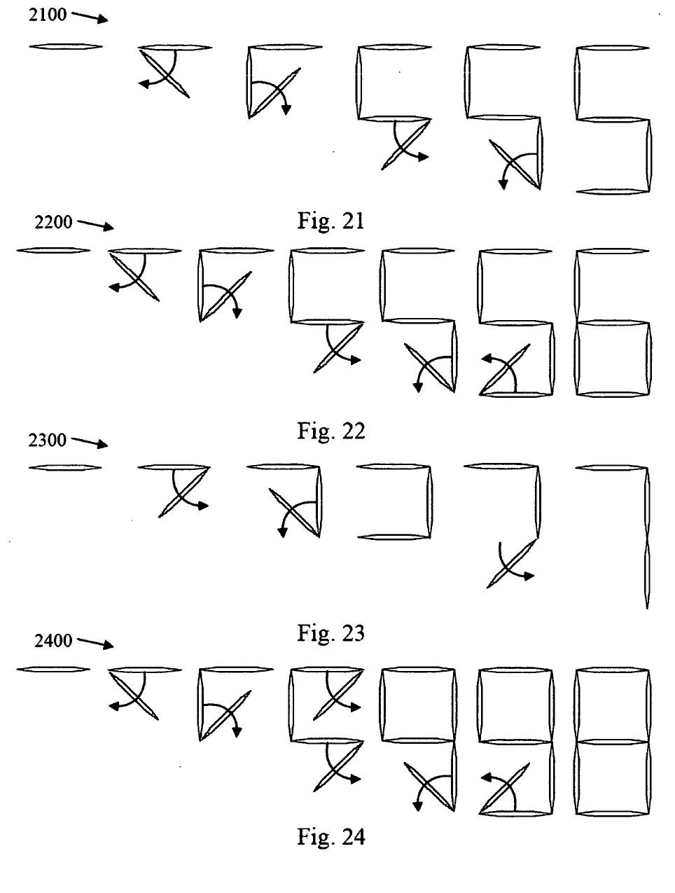

FIG. 22 depicts one embodiment of a method 2200 to transition from a neutral symbol to the numeral 6 of the present invention. The method 2200 starts with location F visible. The method 2200 rotates a visual segment 220 from location F to location A leaving a visual segment 220 in location F. Then the method 2200 rotates a visual segment 220 from location A to location G leaving a visual segment 220 in location A. Thereafter, the method 2200 rotates a visual segment 220 from location G to location D leaving a visual segment 220 in location G. Subsequently, the method 2200 rotates a visual segment 220 from location D to location C leaving a visual segment 220 in location D. Then the method 2200 rotates a visual segment 220 from location C to location B leaving a visual segment 220 in location C to form the numeral 6.

FIG. 23 depicts one embodiment of a method 2300 to transition from a neutral symbol to the numeral 7 of the present invention. The method 2300 starts with location F visible. The method 2300 rotates a visual segment 220 from location F to location E leaving a visual segment 220 in location F. Then the method 2300 rotates a visual segment 220 from location E to location G leaving a visual segment 220 in location E. Thereafter, the method 2300 rotates a visual segment 220 from location G to location D to form the numeral 7.

FIG. 24 depicts one embodiment of a method 2400 to transition from a neutral symbol to the numeral 8 of the present invention. The method 2400 starts with location F visible. The method 2400 rotates a visual segment 220 from location F to location A leaving a visual segment 220 in location F. Then the method 2400 rotates a visual segment 220 from location A to location G leaving a visual segment 220 in location A. Thereafter, the method 2400 rotates a visual segment 220 from location G to location D leaving a visual segment 220 in location G and at the same time rotates a visual segment 220 from location F to location E leaving a visual segment 220 in location F. Subsequently, the method 2400 rotates a visual segment 220 from location D to location C leaving a visual segment 220 in location D. Then the method 2400 rotates a visual segment 220 from location C to location B leaving a visual segment 220 in location C to form the numeral 8.

FIG. 25 depicts one embodiment of a method 2500 to transition from a neutral symbol to the numeral 9 of the present invention. The method 2500 starts with location F visible. The method 2500 rotates a visual segment 220 from location F to location A leaving a visual segment 220 in location F. Then the method 2500 rotates a visual segment 220 from location A to location G leaving a visual segment 220 in location A. Thereafter, the method 2500 rotates a visual segment 220 from location G to location D leaving a visual segment 220 in location G and at the same time rotates a visual segment 220 from location F to location E leaving a visual segment 220 in location F. Subsequently, the method 2500 rotates a visual segment 220 from location D to location C D leaving a visual segment 220 in location D to form the numeral 9.

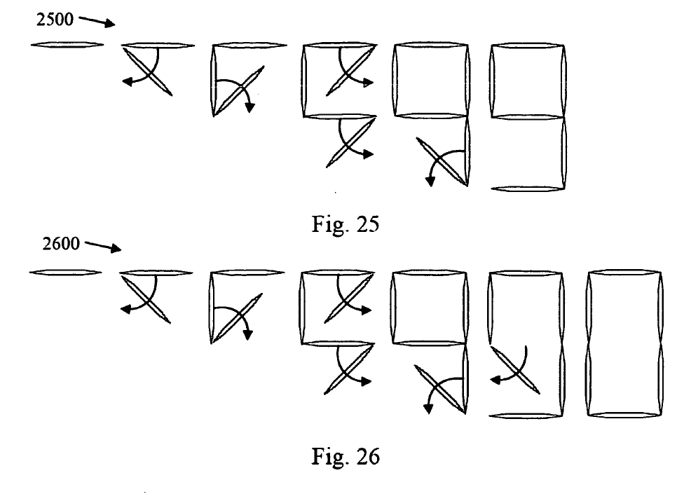

FIG. 26 depicts one embodiment of a method 2600 to transition from a neutral symbol to the numeral 0 of the present invention. The method 2600 starts with location F visible. The method 2600 rotates a visual segment 220 from location F to location A leaving a visual segment 220 in location F. Then the method 2600 rotates a visual segment 220 from location A to location G leaving a visual segment 220 in location A. Thereafter, the method 2600 rotates a visual segment 220 from location G to location D leaving a visual segment 220 in location G and at the same time rotates a visual segment 220 from location F to location E leaving a visual segment 220 in location F. Subsequently, the method 2600 rotates a visual segment 220 from location D to location C leaving a visual segment 220 in location D. Then the method 2600 rotates a visual segment 220 from location G to location B to form the numeral 0.

What is claimed is:

1. An apparatus for displaying and animating symbols, the apparatus comprising:
a plurality of display elements configured to display a selected symbol of a plurality of displayable symbols; and
an animator configured to move at least one selected visual segment from a first position corresponding to a current symbol to a second position corresponding to a subsequent symbol via at least one intermediate position.

2. The apparatus of claim 1, wherein the animator is further configured to morph the selected visual segment.

3. The apparatus of claim 1, wherein the at least one selected visual segment is bar shaped.

4. The apparatus of claim 1, wherein the at least one selected visual segment is a projected beam.

5. The apparatus of claim 1, wherein the at least one selected visual segment comprises a contiguous region of activated pixels.

6. The apparatus of claim 1, wherein the at least one selected visual segment comprises a contiguous region of activated light emitting elements.

7. The apparatus of claim 1, wherein the at least one selected visual segment comprises a bar-shaped region of activated lights.

8. The apparatus of claim 1, wherein the selected at least one visual segment comprises a mechanical dial configured to rotate about a segment junction.

9. The apparatus of claim 1, wherein the at least one intermediate position corresponds to a fixed display segment activated for a finite duration.

10. The apparatus of claim 1, wherein the at least one selected visual segment comprises a plurality of sub-segments.

11. The apparatus of claim 1, wherein the animator is configured to activate and deactivate a luminescent state for each display element of the plurality of display elements.

12. The apparatus of claim 1, wherein the selected symbol is selected from the group consisting of the symbols 0, 1, 2, 3, 4, 5, 6, 7, 8, 9, A, B, C, D, E, and F.

13. A system for displaying symbols, the system comprising:
a display comprising a plurality of symbol fields, each symbol field comprising:
a plurality of display elements configured to display a selected symbol of a plurality of displayable symbols, and
an animator configured to move at least one selected visual segment from a first position corresponding to a current symbol to a second position corresponding to a subsequent symbol via at least one intermediate position.

14. The system of claim 13, wherein animator is further configured to move a symbol field.

15. The system of claim 13, wherein the plurality of symbol fields display a time.

16. The system of claim 13, wherein the plurality of symbol fields display a temperature.
